(19) United States
(12) Patent Application Publication
(10) Pub. No.: US 2008/0036896 A1
(43) Pub. Date: Feb. 14, 2008

(54) PROJECTING ACCOMMODATING DEVICE AND PROJECTING SYSTEM USING THE SAME

(75) Inventor: Chiou-Lin Chung, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BENQ CORPORATION, Taoyuan Shien (TW)

(21) Appl. No.: 11/836,911

(22) Filed: Aug. 10, 2007

(30) Foreign Application Priority Data
Aug. 11, 2006 (TW) 95129640

(51) Int. Cl. H04N 5/222

(52) U.S. Cl. 348/333.01; 348/E05.022

(57) ABSTRACT

A projecting accommodating device used in an electronic device having a display monitor is provided. The accommodating device includes a shell body and a lens. The shell body has a cavity for receiving the electronic device, and the lens is disposed on the shell body. When the electronic device is disposed within the cavity and the display monitor faces the lens, an image displayed on the display monitor can be projected out through the lens.

This application claims the benefit of Taiwan application Serial No. 95129640, filed Aug. 11, 2006, the subject matter of which is incorporated herein by reference.

### BACKGROUND OF THE INVENTION

1. Field of the Invention

The invention relates in general to a projecting accommodating device and the projecting system using the same, and more particularly to a projecting accommodating device used in an electronic device having a display monitor and a projecting system using the same.

2. Description of the Related Art

With the advance in technology, electronic devices such as projector, notebook computer and mobile phone have become popular products in business and household as well. A projector, when connected to a notebook computer, outputs an image from the notebook computer to a large screen, is indispensable in business use. Meanwhile, the projector can be used in a family theater for entertainment purpose. With the high popularity of mobile phone, the mobile phone manufacturers are keen to provide new products equipped with more functions. Currently, in addition to the basic function of communication, the mobile phone can also be used to take photos, to access to the Internet wirelessly, to download and play audio and video, and to store datas.

Most electronic devices such as mobile phone and personal digital assistant (PDA) have a display monitor for facilitating users to operate the electronic devices and read the datas stored within. For the users to operate the electronic devices more conveniently, the display monitor is getting bigger in size and higher in resolution with the rapid advancement in panel technology. However, due to the restriction in the appearance and portability of electronic devices, the display monitor size of a mobile phone is still restricted. Therefore, how to provide the users with more functions under the restrictions of the display monitor size has become a focus for the manufacturers.

### SUMMARY OF THE INVENTION

The invention is directed to a projecting accommodating device and the projecting system using the same. An electronic device having a display monitor is disposed on the projecting accommodating device and the display monitor corresponds to a lens of the projecting accommodating device, such that an image shown on the display monitor can be projected out through the lens, and a user can use the electronic device during night time. Meanwhile, by disposing an electrical connector on the projecting accommodating device, the electronic device can also be charged when the projecting accommodating device is in use.

According to a first aspect of the present invention, a projecting accommodating device used in an electronic device having a display monitor is provided. The accommodating device includes a shell body and a lens. The shell body has a cavity for receiving the electronic device, and the lens is disposed on the shell body. When the electronic device is disposed within the cavity and the display monitor faces the lens, an image shown on the display monitor can be projected out through the lens.

According to a second aspect of the present invention, a projecting system comprising an accommodating device and an electronic device is provided. The accommodating device includes a shell body and a lens. The shell body has a cavity, and the lens is disposed on the shell body. The electronic device is selectively disposed on the accommodating device and has a display monitor for shown an image. When the electronic device is disposed within the cavity and the display monitor faces the lens, the image of the display monitor can be projected out through the lens.

The invention will become apparent from the following detailed description of the preferred but non-limiting embodiments. The following description is made with reference to the accompanying drawings.

### BRIEF DESCRIPTION OF THE DRAWINGS

FIG. 1A is a perspective of a projecting accommodating device in a charging mode according to a preferred embodiment of the invention;

FIG. 1B is a perspective of the projecting accommodating device of FIG. 1A in a projecting mode;

FIG. 2 is an exploded diagram of the lens of FIG. 1A;

FIG. 3 is a partial exploded diagram of the projecting accommodating device of FIG. 1A;

FIGS. 4A˜4B are diagrams showing the operation of a projecting system using the projecting accommodating device of FIG. 1B in a projecting mode;

FIG. 5 is a diagram showing the operation of the projecting system of FIG. 4B; and

FIG. 6 is a diagram of the projecting accommodating device of FIG. 1A in use.

### DETAILED DESCRIPTION OF THE INVENTION

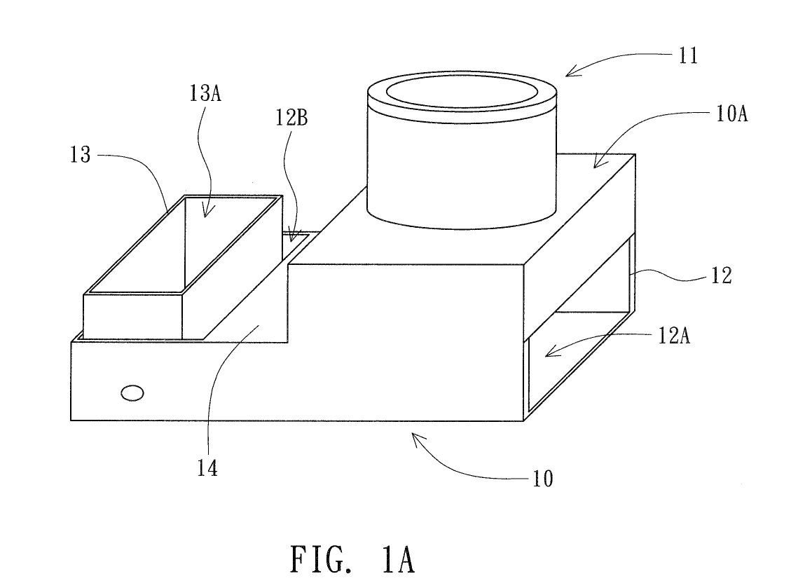

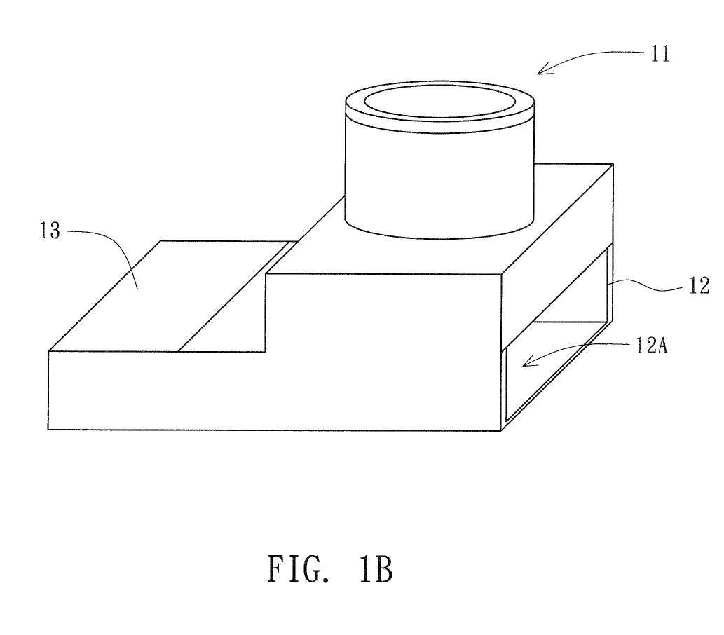

Refer to FIGS. 1A˜1B. FIG. 1A is a perspective of a projecting accommodating device in a charging mode according to a preferred embodiment of the invention. FIG. 1B is a perspective of the projecting accommodating device of FIG. 1A in a projecting mode. As indicated in FIG. 1A, the projecting accommodating device 1 includes a shell body 10 and a lens 11. The lens 11 is disposed on the shell body 10. The shell body 10 has a cavity 12. When an electronic device having a display monitor (not illustrated) is disposed within the cavity 12 and the display monitor faces the lens 11, an image shown on the display monitor can be projected out thruogh the lens 11.

In FIG. 1A, the cavity 12 has a first opening 12A and a second opening 12B, which are not parallel to each other and are respectively disposed on two sides of the shell body 10. Preferably, the direction of the first opening 12A is substantially perpendicular to that of the second opening 12B. The projecting accommodating device 1 further includes a socket 13 pivotally disposed on the shell body 10 and received in the second opening 12B, such that the socket 13 is movable with respect to the shell body 10. The socket 13 has a socket opening 13A. When the socket 13 is rotated to make the socket opening 13A substantially parallel to second opening 12B, the electronic device is loaded into the socket 13 via the second opening 12B and stands nearly vertically in the socket 13. When the socket 13 is rotated to make the socket opening 13A face the first opening 12A, as indicated in FIG. 1B, the electronic device is loaded into the cavity 12 via the first opening 12A, one side of the electronic device is within the socket 13 and the display monitor faces the lens.

The shell body 10 preferably has a plate 14. For convenience, most electronic devices have a light-emitting keyboard for users to operate the electronic devices at nights. Thus, when the electronic device is disposed within the cavity 12, the plate 14 can cover the keyboard of the electronic device to effectively block the light emitted from the keyboard, further improving the effect of projecting an image from the display monitor.

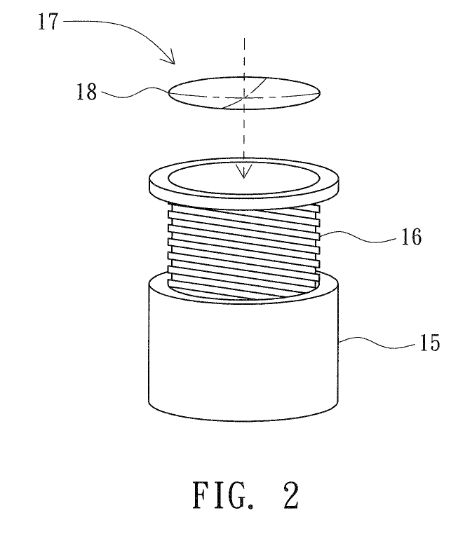

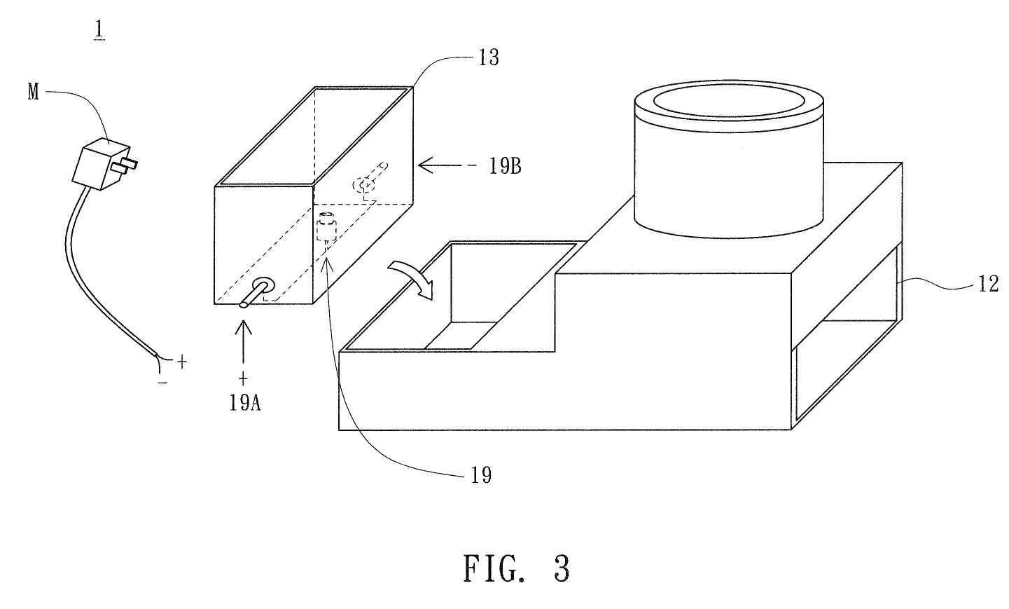

Referring to FIG. 2, an exploded diagram of the lens of FIG. 1A is shown. As indicated in FIG. 2, the lens 11 has a first cylinder 15, a second cylinder 16 and a lens set 17. The first cylinder 15 is connected to a top surface 10A of the shell body 10. The second cylinder 16 is coupled to the first cylinder 15 and is movable with respect to the first cylinder 15. The lens set 17 is fixed on the second cylinder 16. Preferably, the first cylinder 15 and the second cylinder 16 are coupled by an inner screw thread and an outer screw thread, such that when the second cylinder 16 is rotated, the lens set 17 is moved at the same time for adjusting the distance between the lens set 17 and the top surface 10A.

The lens set 17 has at least a convex lens 18. When the display monitor faces the lens 11, by adjusting the distance between the convex lens 18 and the top surface 10A to set the distance between the display monitor and the convex lens 18 to range from one to two times of the focal length of the convex lens 18. Therefore, the image shown on the display monitor can be clearly projected from the lens 11. Preferably, the area of the lens 11 is approximately equal to that of the display monitor, or the area of the lens 11 is slightly larger than that of the display monitor.

Referring to FIG. 3, a partial exploded diagram of the projecting accommodating device of FIG. 1A is shown. As indicated in FIG. 3, the projecting accommodating device 1 further includes an electrical connector 19 disposed within the cavity 12. The electronic device can be electrically connected to the electrical connector 19 that provides a voltage to charge the electronic device. The electrical connector 19 has a positive terminal 19A and a negative terminal 19B externally connected to a transformer M. When the electronic device is disposed within the cavity 12 and is electrically connected to the electrical connector 19, the plug of the transformer M is externally connected to a voltage source for charging the electronic device. Preferably, the electrical connector 19 is disposed on the socket 13. According to the above design, no matter the electronic device is horizontally or loaded into the cavity 12 or is inserted in the socket 13 vertically, the electronic device can use the projecting accommodating device 1 as a charger.

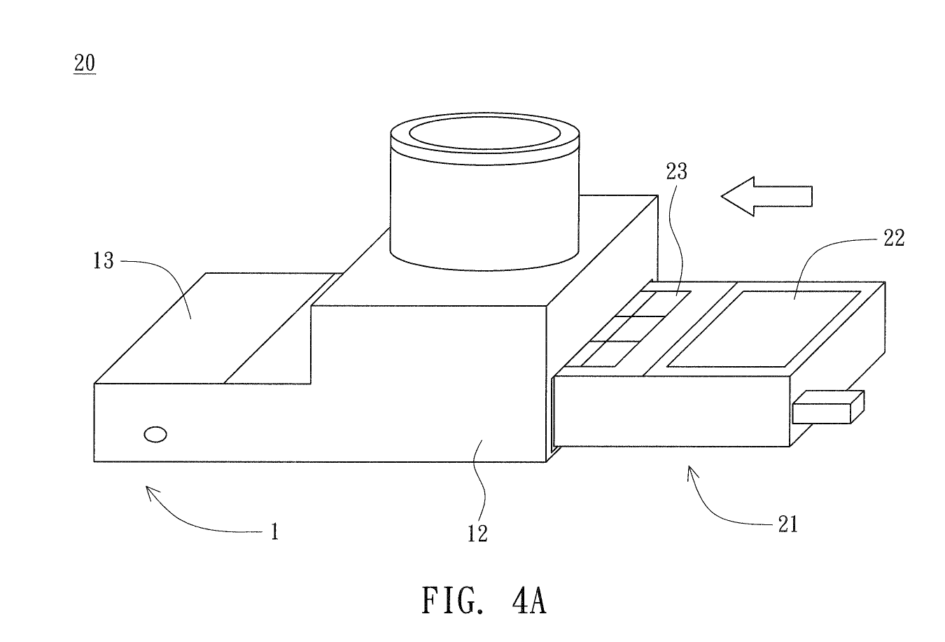

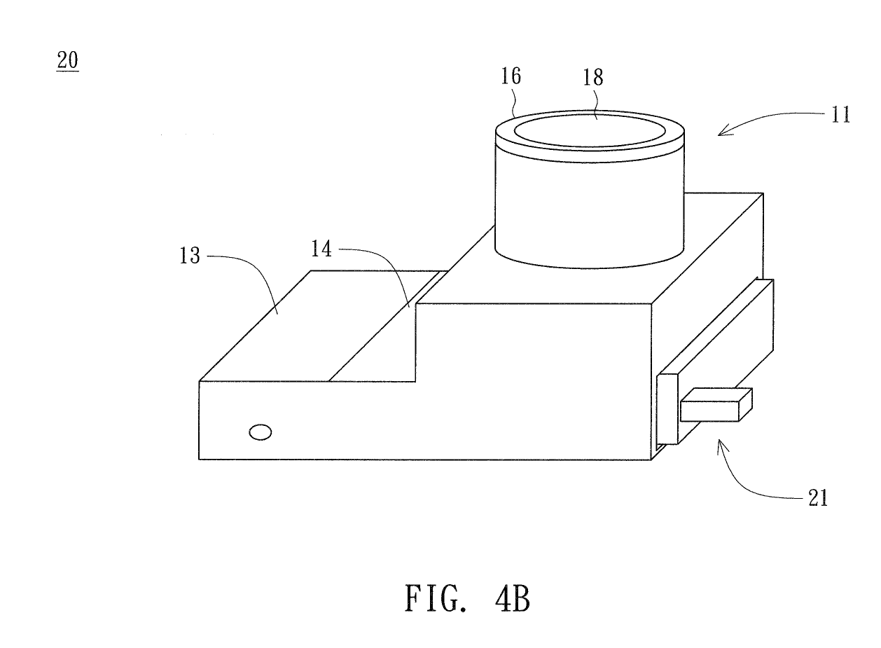

The cooperation between the electronic device and the projecting accommodating device 1 is disclosed below. Referring to FIGS. 4A˜4B, diagrams showing the operation of a projecting system using the projecting accommodating device of FIG. 1B in a projecting mode are shown. As indicated in FIG. 4A, the projecting system 20 is composed of the projecting accommodating device 1 and an electronic device 21. The electronic device 21 has a display monitor 22 and a keyboard 23. The electronic device 21 is selectively disposed on the projecting accommodating device 1. When the user would like to use the projecting accommodating device 1 to project the image shown on the display monitor 22, the electronic device 21 can be loaded into the cavity 12 via the first opening 12A (referring to FIG. 1A) of the projecting accommodating device 1. As indicated in FIG. 4B, the display monitor 22 faces the lens 11, and the plate 14 covers the keyboard 23. The user can then adjust the distance between the display monitor 22 and the convex lens 18 by rotating the second cylinder 16. When the distance between the display monitor 22 (referring to FIG. 4A) and the convex lens 18 ranges from one to two times of the focal length of the convex lens 18, the image is enlarged and clearly projected.

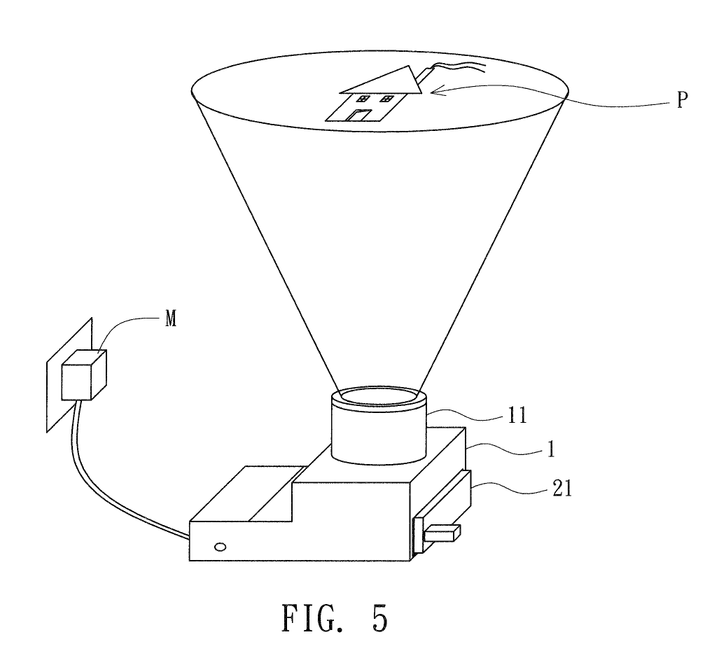

Referring to FIG. 5, a diagram showing the operation of the projecting system of FIG. 4B is shown. As indicated in FIG. 5, when the electronic device 21 is disposed on the projecting accommodating device 1 and the electronic device 21 is activated, as the display monitor 22 faces the lens 11, the image shown on the display monitor 22 is projected onto a screen or wall in a suitable distance from the lens 11.

Preferably, when the electronic device 21 is disposed within the cavity 12, the display monitor 22 has a first illuminance, and when the electronic device 21 is separated from the cavity 12, the display monitor 22 has a second iluminance. The first illuminance is substantially larger than the second luminance. That is, when the electronic device 21 is disposed within the cavity 12, the illuminance of the display monitor 22 is enhanced such that the image shown on the display monitor 22 can be clearly projected onto a screen or a wall.

Thus, the electronic device 21 preferably has a projecting mode. After the electronic device 21 is disposed within the cavity 12, the projecting mode is activated at the same time. For example, the electronic device 21 has a sensor (not illustrated). When the electronic device 21 is disposed within the cavity 12, the sensor is activated at the same time, such that the electronic device 21 is switched to the projecting mode, and the display monitor 22 displays a frame with a first illuminance. When the electronic device 21 is separated from the cavity 12, the sensor enables the electronic device 21 to be switched to the original mode and enables the display monitor 22 to display a frame with a second illuminance. The sensor can be embodied by a touch-controlled element, an RFID or a photosensitive element. Furthermore, the electronic device 21 can has a projecting function menu. When the projecting function menu is activated, the electronic device 21 is switched to the projecting mode. Meanwhile, as the projecting mode is activated, the illuminance of the display monitor 22 can be automatically enhanced. After the projecting mode is activated, the controlling unit of the electronic device 21 generates a to-be-projected image according to an original image, wherein the to-be-projected image P is an inverted image of the original image.

When the projecting accommodating device 1 is used for projecting an image, the electronic device 21 can be charged at the same time. The electronic device 21 is electrically connected to the electrical connector 19 and the transformer M of FIG. 3 first, then the transformer M is externally connected to a voltage source such as a household alternate current. The voltage source, having been converted to a direct current by the transformer M, is able to charge the electronic device 21 via the electrical connector 19.

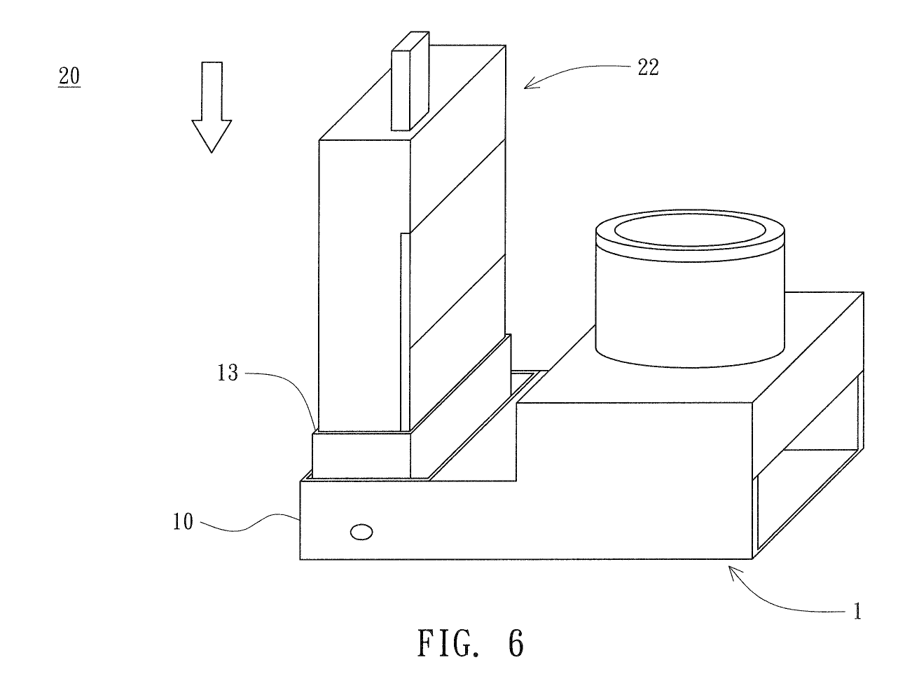

Referring to FIG. 6, a diagram of the projecting accommodating device of FIG. 1A in use is shown. As indicated in FIG. 6, when the user would like to charge the electronic device 21 only, the socket 13 of the projecting accommodating device 1 is rotated to an angle with respect to the shell body 10, such that the electronic device 21 is directly loaded into the socket 13 and stands in the socket 13 vertically. Then, the electronic device 21 is ready to be charged.

The projecting accommodating device 1 provides the user with more functions when using the electronic device 21. Examples of the electronic device 21 include mobile phone or personal digital assistant (PDA), or other electronic devices having a display monitor. The electronic device 21 can project images as long as the electronic device 21 is installed on the projecting accommodating device 1. The user can input a to-be-projected image, such as a picture of a storybook, to the electronic device 21, and set the electronic device 21 to be in the projecting mode and a playing mode. The image will be displayed in a scrolling banner, and projected onto a screen or a wall. When parents are telling a bedside story to their children, the parents can tell the story and at the same time display the images of the story to make the storytelling more interesting and lively. When the projecting accommodating device 1 is used during nighttime, the user can turn off the light to make the image easier and clearer to be viewed.

Most electronic devices rely on a power supply to function normally. Because the projecting accommodating device can be used as a charger of the electronic device, when using the projecting accommodating device, the user does not need to worry about if the battery of the electronic device runs flat and the display of the image is terminated.

According to the projecting accommodating device and the projecting system using the same disclosed in the above embodiments of the invention, an electronic device having a display monitor is incorporated with a projecting accommodating device having a lens, such that the image shown on the display monitor is projected out through the lens for providing the user with another function selection. The projecting accommodating device has a lens, so the user can conveniently adjust the size of the to-be-projected image. Meanwhile, no matter whether the user uses the projecting accommodating device for projecting an image or not, the user can use the projecting accommodating device as a charger of the electronic device. The projecting accommodating device is not costive and suffices to equip the electronic device, such as mobile phone and PDA, with projecting function. Thus, the user would have enjoyment while projecting without spending much money. Therefore, the projecting accommodating device and the projecting system using the same of the invention are very competitive in the market.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projecting accommidating device for using with an electronic device having a display monitor, the projecting device comprising:
a shell body having a cavity for receiving the electronic device; and
a lens disposed on the shell body, wherein when the electronic device is disposed within the cavity and the display monitor faces the lens, an image shown on the display monitor is projected out through the lens.

2. The projecting accommidating device according to claim 1, wherein the cavity has a first opening and a second opening not parallel to the first opening, the projecting device further comprises:
a socket pivotally disposed on the shell body and received in the second opening, the socket having a socket opening;
when the socket is rotated to make the socket opening face the first opening, the electronic device is loaded into the cavity via the first opening, the electronic device is inserted into the socket, and the display monitor faces the lens;
when the socket is rotated to make the socket opening be substantially parallel to the second opening, the electronic device is loaded into the socket via the second opening and stands within the socket nearly vertically.

3. The projecting accommidating device according to claim 1, further comprising:
an electrical connector disposed within the cavity, wherein the electronic device is electrically connected to the electrical connector which provides a voltage to charge the electronic device.

4. The projecting accommidating device according to claim 1, wherein the lens comprises:
a first cylinder connected to a top surface of the shell body;
a second cylinder coupled to the first cylinder and movable with respect to the first cylinder; and
a lens set fixed on the second cylinder;
wherein the second cylinder is movable with respect to the first cylinder for adjusting the distance between the lens and the top surface of the shell body.

5. The projecting accommidating device according to claim 4, wherein the lens set comprises at least a convex lens.

6. The projecting accommidating device according to claim 5, wherein when the display monitor faces the lens, the distance between the display monitor and the convex lens ranges from one to two times of the focal length of the convex lens.

7. The projecting accommidating device according to claim 1, wherein the area of lens is substantially equal to that of the display monitor.

8. The projecting accommidating device according to claim 1, wherein the shell body further comprises a plate, the electronic device further comprises a keyboard, and when the electronic device is disposed within the cavity, the plate covers the keyboard.

9. The projecting accommidating device according to claim 1, wherein when the electronic device is disposed within the cavity, the display monitor has a first luminance, and when the electronic device is separated from the cavity, the display monitor has a second luminance substantially smaller than the first luminance.

10. A projecting system, comprising:
an accommodating device, comprising:
a shell body having a cavity; and
a lens disposed on the shell body;
an electronic device selectively inserted within the cavity and the electronic device having a display monitor for showing an image;
wherein, when the electronic device is inserted within the cavity and the display monitor faces the lens, the image is projected out throught the lens.

11. The projecting system according to claim 10, wherein the cavity has a first opening and a second opening not parallel to the second opening, the accommodating device further comprises:
a socket pivotally disposed on the shell body and received in the second opening and having a socket opening;
when the socket is rotated to make the socket opening face the first opening, the electronic device is loaded into the cavity via the first opening, one side of the electronic device is inserted into the socket, and the display monitor faces the lens;
when the socket is rotated to make the socket opening be substantially parallel to the second opening, the electronic device is loaded into the socket via the second opening and stands within the socket nearly vertically.

12. The projecting system according to claim 10, wherein the accommodating device further comprises an electrical connector disposed within the cavity, the electronic device is electrically connected to the electrical connector which provides a voltage to charge the electronic device.

13. The projecting system according to claim 10, wherein the lens comprises:
a first cylinder connected to a top surface of the shell body;
a second cylinder coupled to the first cylinder and movable with respect to the first cylinder; and
a lens set fixed on the second cylinder;
wherein the second cylinder is movable with respect to the first cylinder for adjusting the distance between the lens and the top surface of the shell body.

14. The projecting system according to claim 10, wherein the area of the lens is substantially equal to that of the display monitor.

15. The projecting system according to claim 10, wherein when the electronic device is disposed within the cavity, the display monitor has a first luminance, and when the electronic device is separated from the cavity, the display monitor has a second luminance substantially smaller than the first luminance.

16. The projecting system according to claim 10, wherein the electronic device has a projecting mode.

17. The projecting system according to claim 16, wherein the electronic device further comprises a sensor, and when the electronic device is disposed within the cavity, the sensor is activated such that the electronic device is switched to the projecting mode.

18. The projecting system according to claim 16, wherein the electronic device has a projecting function menu, and after the projecting function menu is activated, the electronic device is switched to the projecting mode.

19. The projecting system according to claim 16, wherein when the electronic device is in the projecting mode, the iluminance of the display monitor is automatically enhanced.

20. The projecting system according to claim 16, wherein the electronic device has a controlling unit, and when the projecting mode is activated, the controlling unit generates the image that is an inverted image of an original image.
